(19) United States
(12) Patent Application Publication
(10) Pub. No.: US 2013/0264121 A1
(43) Pub. Date: Oct. 10, 2013

(54) GRAPHENE-BASED MATERIAL FOR SHALE STABILIZATION AND METHOD OF USE

(71) Applicants: Steve Young, Cypress, TX (US); James Friedheim, Spring, TX (US); Arvind D. Patel, Sugar Land, TX (US); James Tour, Bellarie, TX (US); Dmitry Kosynkin, Houston, TX (US)

(72) Inventors: Steve Young, Cypress, TX (US); James Friedheim, Spring, TX (US); Arvind D. Patel, Sugar Land, TX (US); James Tour, Bellarie, TX (US); Dmitry Kosynkin, Houston, TX (US)

(73) Assignees: WILLIAM MARSH RICE UNIVERSITY, Houston, TX (US); M-I L.L.C., Houston, TX (US)

(21) Appl. No.: 13/877,852

(22) PCT Filed: Oct. 6, 2011
(86) PCT No.: PCT/US11/55028

§ 371 Date: Jun. 13, 2013

Related U.S. Application Data
(60) Provisional application No. 61/390,348, filed on Oct. 6, 2010.

(51) Int. Cl. C09K 8/035; E21B 7/00

(52) U.S. Cl. CPC C09K 8/035; E21B 7/00
USPC 175/65; 507/127; 507/136; 507/139; 507/129; 507/124

(57) ABSTRACT

Methods and compositions for use in drilling a wellbore into an earthen formation that includes the use of a graphene-based material, where the graphene-based material may be at least one of graphene, graphene oxide, chemically converted graphene, and derivatized graphite oxide are shown and described. In certain examples, the methods and compositions reduce permeability damage and/or stabilize shales.

### BACKGROUND OF INVENTION

1. Field of the Invention

Embodiments disclosed herein relate generally to methods for stabilizing shales during drilling. In particular, embodiments disclosed herein relate to methods of using wellbore fluids that contain graphene-based materials.

2. Background Art

Hydrocarbons are found in subterranean formations. Production of such hydrocarbons is generally accomplished through the use of rotary drilling technology, which requires the drilling, completing and working over of wells penetrating producing formations.

To facilitate the drilling of a well, fluid is circulated through the drill string, out the bit and upward in an annular area between the drill string and the wall of the borehole. Common uses for wellbore fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, transmitting hydraulic horsepower to the drill bit, fluid used for emplacing a packer, abandoning the well or preparing the well for abandonment, and otherwise treating the well or the formation.

The selection of the type of wellbore fluid to be used in a drilling application involves a careful balance of both the good and bad characteristics of the wellbore fluids in the particular application and the type of well to be drilled. However, historically, aqueous based wellbore fluids have been used to drill a majority of wells. Their lower cost and better environment acceptance as compared to oil based wellbore fluids continue to make them the first option in drilling operations. Frequently, the selection of a fluid may depend on the type of formation through which the well is being drilled.

The types of subterranean formations intersected by a well typically may include formations having clay minerals as major constituents, such as shales, mudstones, siltstones, and claystones. Such formations usually have to be penetrated before reaching the hydrocarbon bearing zones. Shale is the most common, and certainly the most troublesome, rock type that must be drilled in order to reach oil and gas deposits. The characteristic that makes shales most troublesome to drillers is its water sensitivity, due in part to its clay content and the ionic composition of the clay. Shales are also troublesome because they have a very low (nano-Darcy) permeability with very small (nanometer) sized pore throats that are not effectively sealed by the solids in conventional wellbore fluids.

In penetrating through such formations, many problems are frequently encountered, including bit balling, swelling or sloughing of the wellbore, stuck pipe, and dispersion of drilled cuttings. This may be particularly true when drilling with a water-based wellbore fluid due to the tendency of clay to become unstable on contact with water (i.e., in an aqueous environment), which may result in tremendous losses of operation time and increases in operation costs. When dry, the clay has too little water to stick together, and it is thus a friable and brittle solid. Conversely, in a wet zone, the material is essentially liquid-like with very little inherent strength and may be washed away. However, intermediate to these zones, the shale is a sticky plastic solid with greatly increased agglomeration properties and inherent strength.

The unstable tendency of water-sensitive shales may be related to water adsorption and hydration of clays. When a water-based wellbore fluid comes in contact with shales, water adsorption occurs immediately. This may cause clays to hydrate and swell, which may result in stress and/or volume increases. Stress increases may induce brittle or tensile failure of the formations, leading to sloughing cave in, bit balling, and stuck pipe. Volume increases, on the other hand, may reduce the mechanical strength of shales and cause swelling of wellbore, disintegration of cuttings in wellbore fluid, and balling up of drilling tools. Bit balling reduces the efficiency of the drilling process because the drillstring eventually becomes locked. This causes the drilling equipment to skid on the bottom of the hole preventing it from penetrating uncut rock, therefore slowing the rate of penetration. Furthermore the overall increase in bulk volume accompanying clay swelling impacts the stability of the borehole, and impedes removal of cuttings from beneath the drill bit, increases friction between the drill bit and the sides of the borehole, and inhibits formation of the thin filter cake that seals formations. The downtime associated with either soaking the bit or tripping the bit may be very costly and is therefore undesirable. Typically, chemical means (i.e., maintaining a positive osmotic balance for an invert emulsion wellbore fluid, or ensuring maintenance of the correct type and sufficient concentration(s) of inhibitor for water based wellbore fluids) are employed to minimize any interaction between the wellbore fluid and the shales. However, the best way to minimize these drilling problems is to prevent water adsorption and clay hydration from occurring, and oil-based wellbore fluids are believed to be the most effective for this purpose.

The inhibitive action of oil-based wellbore fluids arises from the emulsification of brine in oil, which acts as a semi-permeable barrier that materially separates the water molecules from being in direct contact with the water-sensitive shales. Nevertheless, water molecules may flow through this semi-permeable barrier when the water activity of the oil-based wellbore fluid differs from that of the shale formation. To prevent water molecules from being osmotically drawn into shale formations, the water activity of the oil-based wellbore fluid is usually adjusted to a level equal to or less than that of the shales. Due to their detrimental impacts on environments, oil-based fluids are subject to more stringent restrictions in their usage, and oftentimes water-based wellbore fluids must be used instead. Thus, there is a need to improve the inhibitive properties of water-based wellbore fluids so that water adsorption and hydration of clays may be controlled and/or minimized.

Treating water-based wellbore fluids with inorganic chemicals and polymer additives is a common technique used to reduce hydration of shales. However, high concentrations of inorganic cations, polymer additives, glycols, and similar compounds not only increase the wellbore fluid cost, but also may cause severe problems with control of mud properties and suspension of weighting agents, especially at high mud weights and high solids contents. This again may be related to the lack of water, which helps many mud additives to solubilize and function properly. Therefore, in order to reduce cost and particularly to minimize these undesirable side effects, the concentration of such additives should be minimized.

Thus, given the frequency in which shale is encountered in drilling subterranean wells, there exists a continuing need for methods of drilling using wellbore fluids that will reduce potential problems encountered when drilling through shales such as with dispersion of shales, cuttings accretion and agglomeration, cuttings build up, bit balling, and hole cleaning.

### SUMMARY OF INVENTION

In one aspect, embodiments disclosed herein relate to methods for stabilizing shales while drilling a wellbore into an earthen formation that includes circulating a wellbore fluid into the wellbore while drilling through shales. In certain embodiments, the wellbore fluid includes a graphene-based material selected from graphene, graphene oxide, chemically converted graphene, and derivatized graphite oxide, wherein the graphene-based material is present in a sufficient weight percent to stabilize the shales.

In another aspect, embodiments disclosed herein relate to wellbore fluids that include a base fluid, and a graphene-based material, wherein the surface of the graphene-based material is functionalized with at least one of carboxyl groups, amines, quaternary amines, ethoxylated ethers, propoxylated ether, glycol derived groups, polyglycol, polyvinyl alcohol, silanes, silane oxides, and combinations thereof.

In another aspect, embodiments disclosed herein relate to methods for reducing permeability damage in an earthen formation, that includes circulating a wellbore fluid while drilling through shales, wherein the wellbore fluid comprises a graphene-based material selected from graphene, graphene oxide, chemically converted graphene, and derivatized graphite oxide, wherein the graphene-based material is present in a sufficient weight percent to reduce the permeability of the shales.

Other aspects and advantages of the invention will be apparent from the following description and the appended claims.

### BRIEF DESCRIPTION OF THE DRAWINGS

FIG. 1 shows an embodiment of the present disclosure whereby wellbore fluids including a graphene-based material may prevent or substantially reduce water from contacting a shale formation.

FIG. 2 shows an embodiment of the present disclosure whereby wellbore fluids including a graphene-based material may prevent or substantially reduce water from contacting a shale formation.

FIG. 3 shows a synthetic scheme for production of functionalized chemically converted graphenes.

### DETAILED DESCRIPTION

In one aspect, embodiments disclosed herein relate to a wellbore fluid for use in drilling wells through a shale, wherein the wellbore fluid may be water-based or oil-based and includes, inter alia, a graphene-based material, which may be activated or functionalized. As disclosed below, the fluids of the present disclosure may optionally include additional components, such as weighting agents, viscosity agents, fluid loss control agents, bridging agents, lubricants, corrosion inhibition agents, alkali reserve materials and buffering agents, surfactants and suspending agents, rate of penetration enhancing agents and the like that one of skill in the art would appreciate may be added to a wellbore fluid.

The inventors of the present application have surprisingly discovered that, when added to wellbore fluids, graphene-based materials may reduce or prevent dispersion of drilled shale or clay cuttings into the wellbore fluid. The inventors have also surprisingly discovered that such graphene-based materials may be suitable for use in both water-based wellbore fluids as well as invert emulsion (water-in-oil) wellbore fluids.

Frequently, the type of wellbore fluid additive used depends on numerous factors, including the type of formation to be encountered, planned depth of the well, and the temperatures expected to be encountered downhole. Various polymeric materials (including polyacrylamide or cationic polymers) are known for incorporation into wellbore fluids as shale inhibitors. However, wellbore fluids including graphene-based materials have been found to possess unique properties not possessed by such polymeric additives. The use of wellbore fluids containing these graphene-based materials may give better results than the use of conventional polymers, especially at high temperatures, because they provide good filtration control through low permeability media due to their chemistry, size, and shape. Additionally, the chemical properties of such graphene-based materials as those disclosed herein may be modified such that the surface of the material is activated or functionalized to carry a net cationic or anionic charge that would attract the material to the charged shale formations, thereby resulting in a stronger chemical interaction with the shale body that could provide a significant improvement in shale stability.

### Graphene-Based Materials

As used herein, the term “graphene-based material” is used to refer to, for example, graphene, graphene oxide, graphite oxide, chemically converted graphene, functionalized graphene, functionalized graphene oxide, functionalized graphite oxide, functionalized chemically converted graphene, and combinations thereof. “Graphitic,” as used herein, refers to, for example, graphene and graphite layers.

“Graphene,” as used herein, refers to, for example, a single graphite sheet that is less than about 100 carbon layers thick, and typically less than about 10 carbon layers thick. As used herein, the terms graphene and graphene sheets are used synonymously. As used herein, graphene refers to, for example, graphene oxide, graphite oxide, chemically converted graphene, functionalized chemically converted graphene and combinations thereof.

“Graphene oxide,” as used herein refers to, for example, a specific form of graphite oxide of less than about 100 carbon layers thick, and typically less than about 10 carbon layers thick. Graphene oxide may be produced by any method, including, for example, Hummers' method or by oxidizing graphite in the presence of a protecting agent.

“Graphite oxide,” as used herein, refers to, for example, oxidized graphite having any number of carbon layers.

“Chemically converted graphene,” as used herein, refers to, for example, graphene produced by a reduction of graphene oxide. A reduction of graphene oxide to chemically converted graphene removes at least a portion of oxygen functionalities from the graphite oxide surface.

“Derivatized graphite oxides,” as used herein, refers to, for example, oxidized graphite that has been derivatized with a plurality of functional groups.

“Functionalized chemically converted graphene,” as used herein, refers to, for example, a chemically converted graphene that has been derivatized with a plurality of functional groups.

“Functionalized graphene oxide,” as used herein, refers to, for example, graphene oxide that has been derivatized with a plurality of functional groups.

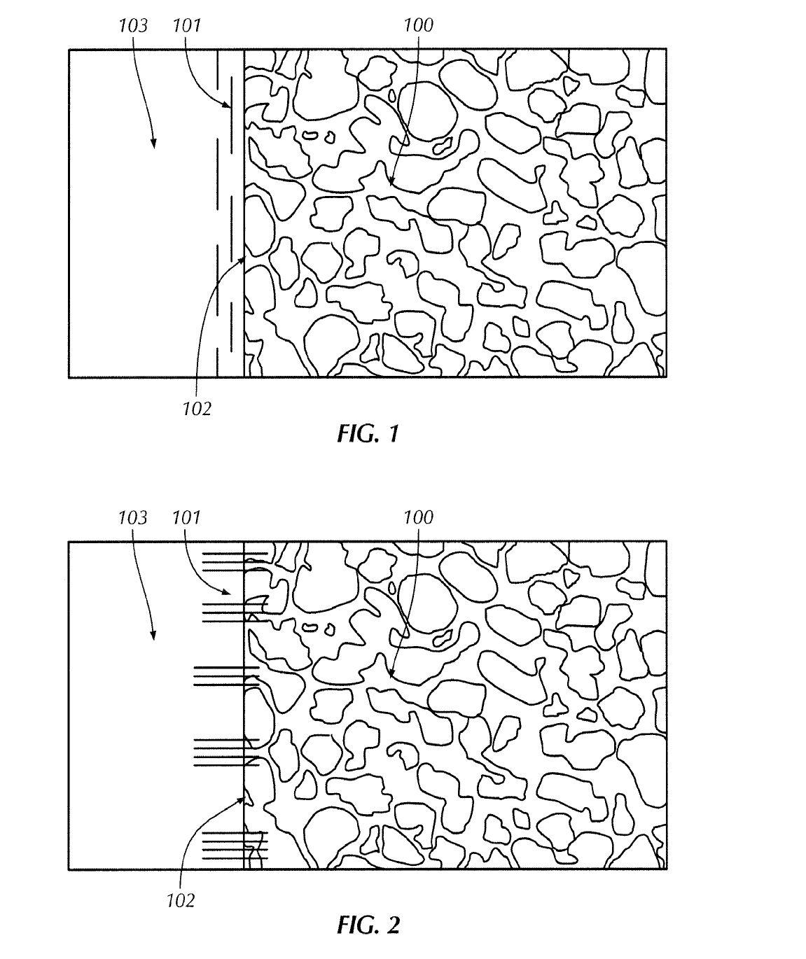

According to embodiments of the present disclosure, graphene-based materials may be included in a wellbore fluid so as to stabilize a shale formation during drilling. The use of graphene or similar nanoplatelet additives in drilling applications may offer several advantages over conventional additives, which are generally spherical. Furthermore, the natural lubricity of graphene, similar to that of graphite, may reduce wear and friction on drill strings within boreholes. As shown in FIG. 1, wellbore fluids including a graphene-based material may reduce or prevent water from contacting a shale formation 100. For example, graphene sheets 101 may sheet or leaf across (as shown in FIG. 1) and thereby plug the pore throats 102, thus preventing water (e.g., from the wellbore fluid) from contacting the shale formation 100. As shown in FIG. 2, the graphene sheets 101 may intercalate and thereby plug the pore throats 102 sideways. The graphene sheets may prevent or substantially reduce water from contacting and thereby causing swelling of the shale formation 100. The graphene sheets are preferably thin, but sufficiently strong and flexible and of sufficient size to span at least one pore of the shales. Generally, such pore throats in shales are tens of nanometers to a few microns in nominal diameter. Flexibility of the graphene sheets may allow for slight deformation under pressure (e.g., from the wellbore fluid) to permit sealing of the graphene sheets around pore edges for preventing or substantially reducing water from contacting the shales.

In various embodiments of the present disclosure, wellbore fluids including graphene-based materials are disclosed. In some embodiments, the graphene-based materials are present in a concentration range of about 0.0001% to about 10% by volume of the wellbore fluid. In other embodiments, the graphene-based materials are present in a concentration range of about 0.01% to about 0.1% by volume of the wellbore fluid.

Wellbore fluids are well known in the art. Non-limiting examples of wellbore fluids include, for example, water-based wellbore fluids and invert emulsion wellbore fluids. The graphene-based materials described herein may be added to any of these wellbore fluids, or a custom wellbore fluid formulation may be prepared.

Various graphene-based materials are suitable for use in the wellbore fluids of the present disclosure. In various embodiments, the graphene-based materials include, for example, graphene oxide, graphite oxide, or a chemically converted graphene. In various embodiments, the chemically converted graphene is prepared by a reduction of graphite oxide. In various embodiments, the reduction of graphite oxide is conducted with hydrazine. Alternative reagents suitable for reducing graphite oxide into chemically converted graphene include, for example, hydroquinone and NaBH₄. Production of chemically converted graphene by hydrazine reduction of graphite oxide is particularly advantageous in producing predominantly individual graphene sheets. Although stable aqueous dispersions of chemically converted graphenes can be prepared, it may be advantageous to use chemically converted graphenes stabilized with a surfactant for further use. For example, in preparing functionalized chemically converted graphenes, higher concentrations of chemically converted graphenes that are obtainable using a surfactant are advantageous for maximizing reaction product yields. In the absence of a surfactant, redispersal of chemically converted graphenes can sometimes be difficult after work-up and recovery. Thus, such surfactants may be selected from those surfactants that are commonly used in wellbore fluid formulation.

In yet other embodiments, the graphene-based materials include, for example, functionalized graphene-based materials. In other embodiments, the graphene-based material (graphene oxide, graphite oxide, chemically converted graphene, etc.) is functionalized with at least one of alkyl groups, carboxyl groups, amines, quaternary amines, ethoxylated ethers, propoxylated ether, glycol derived groups, polyglycol, polyvinyl alcohol, silanes, silane oxides, and combinations thereof. The mechanism(s) of functionalization will depend on the exact nature of the introduced molecules and may include, for example, esterification, etherification, nucleophilic addition including nucleophilic ring opening of epoxides, radical nucleophilic substitution and addition, electrophilic addition, radical addition, dipolar addition, Diels-Alder addition and other similar additions with cyclic intermediates, etc.

Graphene sheets in any of the various graphene-based materials disclosed herein may range from about several hundred nanometers in width up to about a few tens of microns in width in some embodiments and from about several hundred nanometers up to about 1 mm in width or more in other various embodiments. Advantageously, such widths are typically sufficient for plugging shale pores when the graphenes are used in the wellbore fluids disclosed herein. Further, it is also within the scope of the present disclosure that the graphene-based materials used may be sized (in a particular dimension) in a unimodal, bimodal, or multimodal distribution.

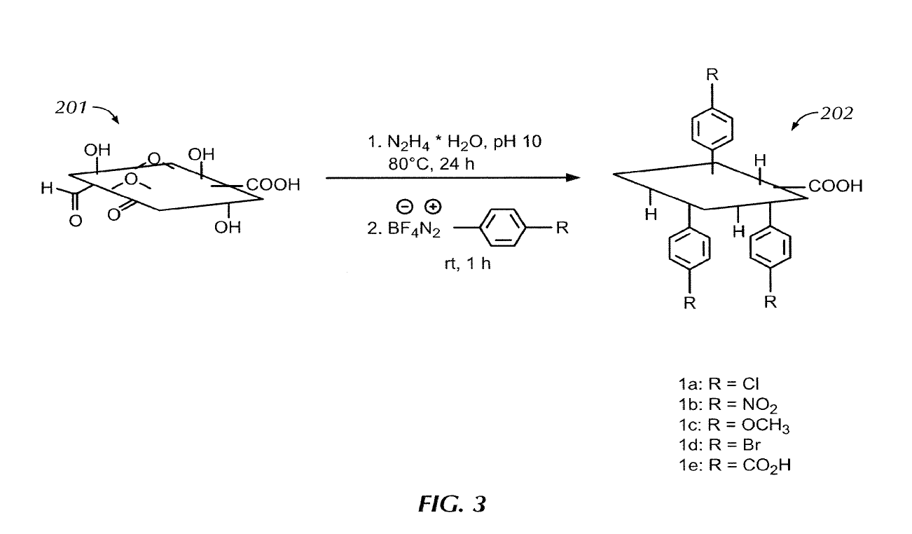

In some embodiments of the wellbore fluids of the present disclosure, the graphene may be functionalized with various functional groups bound to carbon (i.e., not to residual carboxy or hydroxyl moieties) on the graphene surface. As mentioned above, according to some embodiments of the wellbore fluids of the present disclosure, a chemically converted graphene may be functionalized. One means for preparing functionalized chemically converted graphenes is illustrated in FIG. 3. In the illustrative procedure shown in FIG. 3, graphite oxide 201 is reduced with hydrazine to provide a chemically converted graphene (not shown). The chemically converted graphene is then reacted in a second step with a diazonium species to provide functionalized chemically converted graphene 202. For example, as shown in FIG. 3, the diazonium species can be a diazonium salt. The diazonium salt can be as a pre-formed reagent or generated in situ from, for example, an aniline plus sodium nitrite or alkylnirites. The functionalized chemically converted graphenes shown in FIG. 3 are merely illustrative of the functionalized chemically converted graphenes that can be produced using methods described herein. Diazonium salts are well known to those of skill in the art, and any diazonium salt or a diazonium salt prepared in situ can be used for functionalizing the chemically converted graphenes described herein. The wide range of functionalized chemically converted graphenes accessible by the methods described herein allows modification of solubility and other physical properties of the graphene, which may be advantageous in various embodiments of the wellbore fluids. In various other embodiments of the fluids of the present disclosure, the functionalization of a graphene (or graphite) oxide may occur using the epoxide functionalization on the graphene surface or via hydroxyl or carbonyl (carboxyl, ketone, aldehyde, ester etc.) functionality.

The characteristic that makes shales most troublesome to drillers is its water sensitivity, due in part to its clay content and the ionic composition of the clay. These reactive shales contain clays that have been dehydrated over geologic time by overburden pressure. When the shale is exposed during the drilling process, the clays osmotically imbibe water from the wellbore fluid.

Clay minerals are generally crystalline in nature. The structure of a clay's crystals determines its properties. Typically, clays have a flaky, mica-type structure. Clay flakes are made up of a number of crystal platelets stacked face-to-face. Each platelet is called a unit layer, and the surfaces of the unit layer are called basal surfaces. Each unit layer is composed of multiple sheets, which may include octahedral sheets and tetrahedral sheets. Octahedral sheets are composed of either aluminum or magnesium atoms octahedrally coordinated with the oxygen atoms of hydroxyls, whereas tetrahedral sheets consist of silicon atoms tetrahedrally coordinated with oxygen atoms.

Sheets within a unit layer link together by sharing oxygen atoms. When this linking occurs between one octahedral and one tetrahedral sheet, one basal surface consists of exposed oxygen atoms while the other basal surface has exposed hydroxyls. It is also quite common for two tetrahedral sheets to bond with one octahedral sheet by sharing oxygen atoms. The resulting structure, known as the Hoffman structure, has an octahedral sheet that is sandwiched between the two tetrahedral sheets. As a result, both basal surfaces in a Hoffman structure are composed of exposed oxygen atoms. The unit layers stack together face-to-face and are held in place by weak attractive forces. The distance between corresponding planes in adjacent unit layers is called the d-spacing. A clay crystal structure with a unit layer consisting of three sheets typically has a d-spacing of about 9.5×10⁻¹⁰ m or 0.95 nm.

In clay mineral crystals, atoms having different valences commonly will be positioned within the sheets of the structure to create a negative potential at the surface, which causes cations to be adsorbed thereto. These adsorbed cations are called exchangeable cations because they may chemically trade places with other cations when the clay crystal is suspended in water. In addition, ions may also be adsorbed on the clay crystal edges and exchange with other ions in the water.

Exchangeable cations found in clay minerals are reported to have a significant impact on the amount of swelling that takes place. The exchangeable cations compete with water molecules for the available reactive sites in the clay structure. Generally cations with high valences are more strongly adsorbed than ones with low valences. Thus, clays with low valence exchangeable cations will swell more than clays whose exchangeable cations have high valences.

The type of substitutions occurring within the clay crystal structure and the exchangeable cations adsorbed on the crystal surface greatly affect clay swelling, a property of primary importance in the wellbore fluid industry. Clay swelling is a phenomenon in which water molecules surround a clay crystal structure and position themselves to increase the structure's d-spacing thus resulting in an increase in volume. Two types of swelling may occur: surface hydration and osmotic swelling.

Surface hydration is one type of swelling in which water molecules are adsorbed on crystal surfaces. Hydrogen bonding holds a layer of water molecules to the oxygen atoms exposed on the crystal surfaces. Subsequent layers of water molecules align to form a quasi-crystalline structure between unit layers, which results in an increased d-spacing. Virtually all types of clays swell in this manner.

Osmotic swelling is a second type of swelling. Where the concentration of cations between unit layers in a clay mineral is higher than the cation concentration in the surrounding water, water is osmotically drawn between the unit layers and the d-spacing is increased. Osmotic swelling results in larger overall volume increases than surface hydration. However, only certain clays, like sodium montmorillonite, swell in this manner.

When water molecules enter the lattice structure and bond with active sites, the layers expand or eventually disperse into individual particles. Dispersion of clay increases the surface area which in turns causes the clay-water site to expand, and the clay-water suspension to thicken. This leads to swelling of the shale, induced stresses, loss of mechanical strength, and shale failure. Stress increases may induce brittle or tensile failure of the formations, leading to sloughing, cave in, and stuck pipe. Volume increases reduce the mechanical strength of shales and cause swelling of wellbore, disintegration of cuttings in wellbore fluid. Shale failure may lead to shale crumbling into the borehole which places an undue burden on the drill bit. For example, the swelled excavated earth may adhere to the walls of the wellbore and of the drilling equipment and form a compact hard mass which gradually fills the entire wellbore annulus thus reducing the effectiveness of the drilling bit.

Furthermore, shale cuttings which are partially hydrated are typically dispersed into the aqueous based wellbore fluid, or may become tacky and exhibit accretion and/or agglomeration. Dispersion of clay into the aqueous based wellbore fluid may cause the wellbore fluid to thicken. Accretion is the mechanism whereby partially hydrated cuttings stick to parts of the bottomhole assembly and accumulate as a compact, layered deposit. This may have an appreciable adverse impact on drilling operations. Deposits on the bottomhole assembly may reduce the efficiency of the drilling process because the drillstring eventually becomes locked. This in turn may cause the drilling equipment to skid on the bottom of the hole preventing it from penetrating uncut rock, therefore slowing the rate of penetration. Also, partially hydrated shale cuttings may stick together or agglomerate forming clusters in the wellbore fluid. Agglomeration may lead to increases in plastic viscosity, yield point, and gel strength of the wellbore fluid.

According to embodiments of the present disclosure, the permeability of shales may be reduced by plugging their pore throats and thereby building a mudcake that may inhibit or reduce swelling and may also repel water from the shales. The graphene-based materials disclosed herein may act by physically plugging the shale or clay cuttings. These graphene-based materials may be activated or functionalized such that the functional groups attached to the graphene-based materials may plug the lattice structure by penetrating the pores located on the surface of the shale while simultaneously allowing the graphene-based materials to sheet or leaf across the shale surface. Thus, the surface of the plugged shale presented to the well environment may be substantially nonionic and thereby repel water. This may inhibit osmotic swelling and aid in the retention of the shale internal structure. Consequently swelling and disintegration may be reduced.

Additionally, the graphene-based materials disclosed herein may act by changing the surface character of shale cuttings (i.e., forming a “barrier” between the cuttings and water). Specifically, when functional groups attached to the surface of the graphene-based materials interact with shale cuttings, the shale cuttings become surrounded by graphene sheets, whereby the graphene sheets form a barrier that may reduce the interaction between the clay and water. Specifically, graphene sheets may form a layer that encapsulates the entire clay particle. Accordingly, accretion and agglomeration may also be reduced.

In applications where the graphene-based materials are added to wellbore fluids to provide control over dispersion, accretion, and/or agglomeration of shale cuttings, the wellbore fluid may be prepared in a wide variety of formulations. Specific formulations may depend on the stage of drilling at a particular time, for example, depending on the depth and/or the composition of the earthen formation. The graphene-based materials may be added to the wellbore fluid as dry powders or concentrated slurries in water, organic solvents or combinations thereof.

The wellbore fluids including the graphene-based materials may also be used as drilling and reservoir fluids as well as workover and completion fluids. Accordingly, all references to drilling fluids should be interpreted accordingly. In particular embodiments, the wellbore fluid is used as a drilling or reservoir fluid.

The wellbore fluids of the present disclosure may be water-based wellbore fluids having an aqueous fluid as the base fluid. The aqueous fluid may include at least one of fresh water, sea water, brine, mixtures of water and water-soluble organic compounds and mixtures thereof. For example, the aqueous fluid may be formulated with mixtures of desired salts in fresh water. Such salts may include, but are not limited to alkali metal chlorides, hydroxides, or carboxylates, for example. In various embodiments of the wellbore fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates and fluorides. Salts that may be incorporated in a brine include any one or more of those present in natural seawater or any other organic or inorganic dissolved salts. Additionally, brines that may be used in the wellbore fluids disclosed herein may be natural or synthetic, with synthetic brines tending to be much simpler in constitution. In one embodiment, the density of the wellbore fluid may be controlled by increasing the salt concentration in the brine (up to saturation). In a particular embodiment, a brine may include halide or carboxylate salts of monovalent cations of metals such as cesium, potassium, and/or sodium, and/or halide or carboxylate salts of divalent cations of metals, such as calcium, magnesium or zinc.

Alternatively, the wellbore fluids of the present disclosure may be invert emulsion wellbore fluids having an oleaginous external phase and a non-oleaginous internal phase. The oleaginous external phase may be, for example, a liquid and more preferably is a natural or synthetic oil and more preferably the oleaginous fluid is selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, and mixtures thereof. In a particular embodiment, the fluids may be formulated using diesel oil or a synthetic oil as the external phase.

The non-oleaginous fluid used in the formulation of the invert emulsion fluid disclosed herein is a liquid and preferably is an aqueous liquid. More preferably, the non-oleaginous liquid may be selected from the group including sea water, a brine containing organic and/or inorganic dissolved salts, liquids containing water-miscible organic compounds and combinations thereof. For example, the aqueous fluid may be formulated with mixtures of desired salts in fresh water. Such salts may include, but are not limited to alkali metal chlorides, hydroxides, or carboxylates, for example. In various embodiments of the wellbore fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium, salts of chlorides, bromides, carbonates, iodides, chlorates, bromates, formates, nitrates, oxides, phosphates, sulfates, silicates, and fluorides. Salts that may be incorporated in a given brine include any one or more of those present in natural seawater or any other organic or inorganic dissolved salts. Additionally, brines that may be used in the wellbore fluids disclosed herein may be natural or synthetic, with synthetic brines tending to be much simpler in constitution. In one embodiment, the density of the wellbore fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

Further, one skilled in the art would recognize that in addition to graphene-based materials, other additives may be included in either or both of the water-based and invert emulsion wellbore fluids disclosed herein, for instance, weighting agents, viscosifiers, wetting agents, corrosion inhibitors, oxygen scavengers, anti-oxidants and free radical scavengers, biocides, surfactants, dispersants, interfacial tension reducers, pH buffers, mutual solvents and thinning agents.

Weighting agents or density materials suitable for use in the fluids disclosed herein include, for example, galena, hematite, magnetite, iron oxides, illmenite, barite, siderite, celestite, dolomite, calcite, and the like. The quantity of such material added, if any, depends upon the desired density of the final composition. Typically, weight material is added to result in a wellbore fluid density of that can exceed 21 ppg in one embodiment; and ranging from 9 to 16 ppg in another embodiment.

Deflocculants or thinners that may be used in the wellbore fluids disclosed herein include, for example, lignosulfonates, modified lignosulfonates, polyphosphates, tannins, and low molecular weight water soluble polymers, such as polyacrylates. Deflocculants are typically added to a wellbore fluid to reduce flow resistance and control gelation tendencies.

The shale inhibition agents described herein may be added to any of these wellbore fluids, or a custom wellbore fluid formulation may be prepared. Examples of conductivity agents useful in the present disclosure are described in International Publication No. WO 2009/089391, the contents of which are herein incorporated by reference in its entirety.

A wellbore fluid according to the disclosure may be used in a method for drilling a well into a subterranean formation in a manner similar to those wherein conventional wellbore fluids are used. In the process of drilling the well, a wellbore fluid is circulated through the drill pipe, through the bit, and up the annular space between the pipe and the formation or steel casing to the surface. The wellbore fluid performs several different functions, such as cooling the bit, removing drilled cuttings from the bottom of the hole, suspending the cuttings and weighting the material when the circulation is interrupted.

The graphene-based materials may be added to the base fluid on location at the well-site where it is to be used, or it may be carried out at another location than the well-site. If the well-site location is selected for carrying out this step, then the graphene-based materials may immediately be dispersed in a brine, and the resulting wellbore fluid may immediately be emplaced in the well using techniques known in the art.

The graphene-based materials of the present disclosure may be in the form of graphene sheets which may provide good filtration control through low permeability media due to their chemistry, size, and shape, and thus may be used to plug the very small shale pores and effectively shut off the flow of fluid to the shales. Furthermore, the chemical properties of the graphene-based materials may be modified such that the surface of the materials carries a net cationic or anionic charge that may attract the graphene-based material to the charged shale formations, which may result in a stronger chemical interaction with the shale body and thereby provide improved shale stability. Specifically, the surface of the graphene-based materials may be activated or functionalized with at least one of the following groups: alkyl groups, carboxyl groups, amines, quaternary amines, ethoxylated ethers, propoxylated ether, glycol derived groups, polyglycol, polyvinyl alcohol, silanes, silane oxides, and/or other groups which may be capable of effectively plugging the shale pore throats.

In one embodiment of the present disclosure, the functionalized graphene-based materials may provide an effective barrier to large ionic movement into the shales, while allowing movement of water at the same time, and thus forming an osmotic barrier which may allow for the stabilization of the shales to be accomplished by controlling the osmotic properties of the wellbore fluid compared to those of the shales.

Wellbore fluids of the present disclosure containing graphene-based materials may be emplaced into the wellbore using conventional techniques known in the art. The graphene-based materials may be added to the drilling, completion, or workover fluid. The wellbore fluids described herein may be used in conjunction with any drilling or completion operation.

### EXAMPLES

The following examples are provided to more fully illustrate some embodiments of the present disclosure. However, it should be appreciated by those of ordinary skill in the art that compositions described in the following examples are illustrative modes of practice and that the full scope of the invention should not be limited to these examples.

### Example 1

Samples of fluids containing methylated graphene oxide (MeGO) synthesized by replacement of protons with methyl groups through acid-catalyzed esterification based on the techniques described in U.S. Pat. No. 3,998,270, which is herein incorporated by reference in its entirety, and DUO-VIS, a xanthan gum viscosifier available from M-I L.L.C. (Houston, Tex.) were formulated. The samples were subjected to rheological testing and a rolling dispersion test. Dispersion tests were run with Arne clay cuttings by hot rolling 10 g of cuttings in a one-barrel equivalent of mud for 1 hour at room temperature. After rolling the remaining cuttings were screened using a 20 mesh screen and washed with 10% potassium chloride water, dried and then weighed to obtain the percentage recovered. The formulation, rheology data, and percent cuttings recovered are shown in Table 1 below.

TABLE 1

| | | Sample | | |
|---|---|---|---|---|
| | | 1 | 2 | 3 |
| MeGO | ppb | 0.7 | 0.7 | — |
| DuoVis | ppb | — | 0.5 | 0.5 |
| pH | | 10.5 | 10.5 | 10.5 |

Rheological Data

| | | | | | |
|---|---|---|---|---|---|
| | 600 | rpm | 27 | 18 | 15 |
| | 300 | rpm | 20 | 14 | 5 |
| | PV | | 7 | 4 | 10 |
| | YP | | 13 | 10 | 4 |
| Gel | 10S | | 5 | 3 | 5 |
| Gel | 10M | | 7 | 4 | 5 |

| | | | |
|---|---|---|---|
| % Recovery | 69 | 92 | 74 |

### Example 2

Similar samples of fluids were formulated with MeGO, butylated graphene oxide (BuGO) prepared in a similar manner as MeGO, JEFFAMINE® D-230, an organic amine available from Huntsman Performance Products (The Woodlands, Tex.), ethylenediamine, and DUO-VIS. The samples were subjected to rheological testing and a rolling dispersion test similar to Example 1 but for 2 hours of rolling. The data is shown in Table 2 below.

TABLE 2

| | | Sample | | | | | |
|---|---|---|---|---|---|---|---|
| | | 1 | 2 | 3 | 4 | 5 | 6 |
| BuGO | ppb | 0.175 | 0.175 | — | — | 0.5 | — |
| MeGO | ppb | — | 0.7 | — | — | — | 0.5 |
| D-230 | ppb | 10.5 | — | 10.5 | — | 10.5 | — |
| en | ppb | — | — | — | — | — | 10.5 |
| DuoVis | ppb | 0.5 | 0.5 | 0.5 | 0.5 | 0.5 | 0.5 |
| pH | | 11 | 10.8 | 10.5 | 11 | 11 | 10.2 |

Rheological Data

| | | | | | | | |
|---|---|---|---|---|---|---|---|
| 600 | rpm | 13 | 13 | 12 | 8 | 24 | 17 |
| 300 | rpm | 9 | 9 | 8 | 5 | 17 | 12 |
| PV | | 4 | 4 | 4 | 3 | 7 | 5 |
| YP | | 5 | 5 | 4 | 2 | 10 | 7 |

| | | | | | | |
|---|---|---|---|---|---|---|
| % Recovery | 71 | 10 | 48 | 0 | 77 | 70 |

### Example 3

Similar samples of fluids were formulated with MeGO, JEFFAMINE® D-230, an organic amine available from Huntsman Performance Products (The Woodlands, Tex.), and DUO-VIS in 100 mL of water. The samples were a rolling dispersion test similar to Example 1 but were rolled for 30 minutes. The data is shown in Table 3 below.

| Sample | | 1 | 2 | 3 |
|---|---|---|---|---|
| MeGO | g | — | 0.2 | 0.2 |
| DuoVis | ppb | 0.5 | 0.5 | 0.5 |
| D-230 | Wt % | 3 | 3 | — |

| | | | |
|---|---|---|---|
| % Recovery | 36 | 95 | 96 |

### Example 4

Similar samples of fluids were formulated with MeGO, BuGO, JEFFAMINE® D-230, an organic amine available from Huntsman Performance Products (The Woodlands, Tex.), and DUO-VIS in 200 mL of water. Each of the samples were adjusted to pH 9.5. The samples were a rolling dispersion test similar to Example 1 but were rolled for 1 hour. The data is shown in Table 4A and 4B below.

TABLE 4A

Sample

| | | 1 | 2 | 3 | 4 |
|---|---|---|---|---|---|
| MeGO | ppb | — | — | 0.7 | 0.7 |
| BuGO | ppb | — | — | — | — |
| DuoVis | ppb | 0.5 | 0.5 | 0.5 | 0.5 |
| D-230 | Wt % | — | 3 | — | 3 |

| | | | | |
|---|---|---|---|---|
| % Recovery | 12 | 78 | 59 | 84 |

TABLE 4B

Sample

| | | 1 | 2 | 3 | 4 |
|---|---|---|---|---|---|
| MeGO | ppb | — | — | — | — |
| BuGO | ppb | — | — | 0.7 | 0.7 |
| DuoVis | ppb | 0.5 | 0.5 | 0.5 | 0.5 |
| D-230 | Wt % | — | 3 | — | 3 |

| | | | | |
|---|---|---|---|---|
| % Recovery | 22 | 67 | 45 | 74 |

Advantageously, embodiments of the present disclosure provide methods of drilling using wellbore fluids including graphene-based materials. Use of wellbore fluids containing graphene-based materials may be effective in preventing dispersion of shale cuttings into the wellbore fluid. Further, wellbore fluids including graphene-based materials may also be effective in preventing accretion and/or agglomeration of shale cuttings downhole.

While the invention has been described with respect to a limited number of embodiments, those skilled in the art, having benefit of this disclosure, will appreciate that other embodiments may be devised which do not depart from the scope of the invention as disclosed herein. Accordingly, the scope of the invention should be limited only by the attached claims.

What is claimed:

1. A method for stabilizing shales while drilling a wellbore into an earthen formation, comprising:
circulating a wellbore fluid into the wellbore while drilling through shales, wherein the wellbore fluid comprises:
a graphene-based material selected from graphene, graphene oxide, chemically converted graphene, and derivatized graphite oxide, wherein the graphene-based material is present in a sufficient weight percent to stabilize the shales.

2. The method of claim 1, wherein the wellbore fluid is an aqueous based wellbore fluid.

3. The method of claim 1, wherein the aqueous based wellbore fluid comprises an aqueous continuous phase.

4. The method of claim 1, wherein the wellbore fluid is an invert emulsion wellbore fluid.

5. The method of claim 4, wherein the invert emulsion wellbore fluid comprises an oleaginous external phase and a non-oleaginous internal phase.

6. The method of claim 1, wherein the graphene-based material is functionalized with at least one of alkyl groups, carboxyl groups, amines, quaternary amines, ethoxylated ethers, propoxylated ether, glycol derived groups, polyglycol, polyvinyl alcohol, silanes, silane oxides, and combinations thereof.

7. The method of claim 1, wherein the graphene-based material comprises from about 0.1% to about 1% by volume of the wellbore fluid.

8. The method of claim 1, wherein the graphene-based material is chemically converted graphene.

9. The method of claim 8, wherein the chemically converted graphene is prepared by a reduction of graphite oxide.

10. The method of claim 9, wherein the reduction of graphite oxide is conducted with hydrazine.

11. The method of claim 8, wherein the chemically converted graphene is functionalized with at least one of alkyl groups, carboxyl groups, amines, quaternary amines, ethoxylated ethers, propoxylated ether, glycol derived groups, polyglycol, polyvinyl alcohol, silanes, silane oxides, and combinations thereof.

12. The method of claim 1, wherein the wellbore fluid further comprises a surfactant.

13. The method of claim 1, wherein the graphene-based material intercolates and thereby plugs the shales sideways.

14. A wellbore fluid, comprising:
a base fluid; and
a graphene-based material, wherein the surface of the graphene-based material is functionalized with at least one of carboxyl groups, amines, quaternary amines, ethoxylated ethers, propoxylated ether, glycol derived groups, polyglycol, polyvinyl alcohol, silanes, silane oxides, and combinations thereof.

15. A method for reducing permeability damage in an earthen formation, comprising:
circulating a wellbore fluid while drilling through shales, wherein the wellbore fluid comprises a graphene-based material selected from graphene, graphene oxide, chemically converted graphene, and derivatized graphite oxide, wherein the graphene-based material is present in a sufficient weight percent to reduce the permeability of the shales.

16. The method of claim 15, wherein the graphene-based material is functionalized with at least one of alkyl groups, carboxyl groups, amines, quaternary amines, ethoxylated ethers, propoxylated ether, glycol derived groups, polyglycol, polyvinyl alcohol, silanes, silane oxides, and combinations thereof.
